(19) United States
(12) Patent Application Publication
(10) Pub. No.: US 2017/0345295 A1
(43) Pub. Date: Nov. 30, 2017

(54) SYSTEM AND METHOD FOR TRAFFIC FLOW MANAGEMENT USING AN ADAPTIVE LANE SYSTEM

(71) Applicant: Amir MATTAR, Haifa (IL)

(72) Inventor: Amir MATTAR, Haifa (IL)

(21) Appl. No.: 15/164,886

(22) Filed: May 26, 2016

(51) Int. Cl. G08G 1/01

(52) U.S. Cl. CPC G08G 1/0145

(57) ABSTRACT

A method for managing traffic flow on a roadway includes upon meeting a condition, changing a number of traffic lanes from a first number to a second number across a given width of the roadway.

### FIELD OF THE INVENTION

The present invention relates to traffic flow management, and particularly relates to a system and method for traffic flow management using an adaptive traffic lane system.

### BACKGROUND OF THE INVENTION

Traffic congestion has become a worldwide problem, where the density of vehicles (demand) exceeds the roadway availability (supply).

### SUMMARY OF THE INVENTION

There is thus provided, in accordance with some embodiments of the present invention, a method of managing traffic flow on a roadway including, upon meeting a condition, changing a number of traffic lanes from a first number to a second number across a given width of the roadway.

In accordance with some embodiments of the present invention, the condition includes traffic congestion in the roadway, and changing the number of traffic lanes includes changing the number of traffic lanes such that the first number is smaller than the second number.

In accordance with some embodiments of the present invention, changing the number of traffic lanes includes manually changing the number of traffic lanes by a user.

In accordance with some embodiments of the present invention, the method includes changing the number of traffic lanes from the second number to the first number upon assessing a normal traffic flow in the roadway.

In accordance with some embodiments of the present invention, the condition includes a time of day within a time period of traffic congestion.

In accordance with some embodiments of the present invention, the method includes collecting information from one or a plurality of sensors placed at positions along a section of the roadway with traffic lanes delineated by road markings; and computing a traffic parameter in the section of the roadway from the collected information from the one or said plurality of sensors; where changing the number of lanes includes toggling the road markings.

In accordance with some embodiments of the present invention, the traffic parameter includes a vehicular traffic rate in the section, and where collecting the information includes determining, using the one or said plurality of sensors, an average speed of vehicles in the section and a number of vehicles in the section for computing the vehicular traffic rate.

In accordance with some embodiments of the present invention, the one or said plurality of sensors are selected from the group consisting of an inductive loop sensor, a magnetometric sensor, a magnetic induction coil sensor, a microwave radar sensor, an active infrared sensor, a passive infrared sensor, an ultrasonic sensor, an acoustic array sensor, a pneumatic tube sensor, and a video image processing sensor.

In accordance with some embodiments of the present invention, the road markings include painted stripes delineating the traffic lanes with the first number, and lane light markers delineating the traffic lanes with the second number, and where toggling the road markings includes illuminating the lane light markers.

In accordance with some embodiments of the present invention, the road markings include a first set of lane light markers delineating the first number of traffic lanes and a second set of lane light markers delineating the second number of traffic lanes on the roadway, and where toggling the road markings includes switching off the first set of lane light markers and illuminating the second set of lane light markers.

There is further provided, in accordance with some embodiments of the present invention, a traffic flow control system for managing traffic flow on a roadway, including road markings and a controller. The controller is configured to change a number of traffic lanes from a first number to a second number across a given width of the roadway when a condition is met.

In some embodiments of the present invention, the system includes a communication unit for communicating with devices selected from the group consisting of GPS satellites, drones, control towers, wireless base stations, and other traffic flow controllers.

In some embodiments of the present invention, the road markings include lane light markers formed from light emitting diodes.

In some embodiments of the present invention, the road markings include tracking tags to delineate the traffic lanes along the roadway.

### BRIEF DESCRIPTION OF THE DRAWINGS

In order for the present invention, to be better understood and for its practical applications to be appreciated, the following Figures are provided and referenced hereafter. It should be noted that the Figures are given as examples only and in no way limit the scope of the invention. Like components are denoted by like reference numerals.

FIG. 1 schematically illustrates a section of a roadway monitored by multiple sensors, in accordance with some embodiments of the present invention;

FIG. 2 is a flowchart depicting a first method for traffic flow management by adaptive lane control, in accordance with some embodiments of the present invention;

FIG. 3 schematically illustrates a block diagram of a traffic flow controller (TFC), in accordance with some embodiments of the present invention;

FIG. 4A schematically illustrates a first configuration for increasing a number of traffic lanes by toggling road markings along a section of a roadway, in accordance with some embodiments of the present invention;

FIG. 4B schematically illustrates a second configuration for increasing a number of traffic lanes by toggling road markings along a section of a roadway, in accordance with some embodiments of the present invention;

FIG. 4C schematically illustrates a third configuration for increasing a number of traffic lanes by toggling road markings along a section of a roadway, in accordance with some embodiments of the present invention; and

FIG. 5 is a flowchart depicting a second method for traffic flow management by adaptive lane control, in accordance with some embodiments of the present invention.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, us of the conjunction “or” as used herein is to be understood as inclusive (any or all of the stated options).

Traffic flow of vehicles along a section of a roadway is the rate at which vehicles pass a given point on the roadway in a given time. “Roadway” in the context of the present specification refers to any road designed for allowing vehicles to travel along, which includes one or more substantially parallel lanes, which are typically marked on the road. The analysis of traffic flow is a complex process that depends on roadway parameters such as the number or density of vehicles on the roadway, the number and width of the lanes, the speed of the vehicles, as well as the interaction between vehicles on the road system (e.g., human drivers).

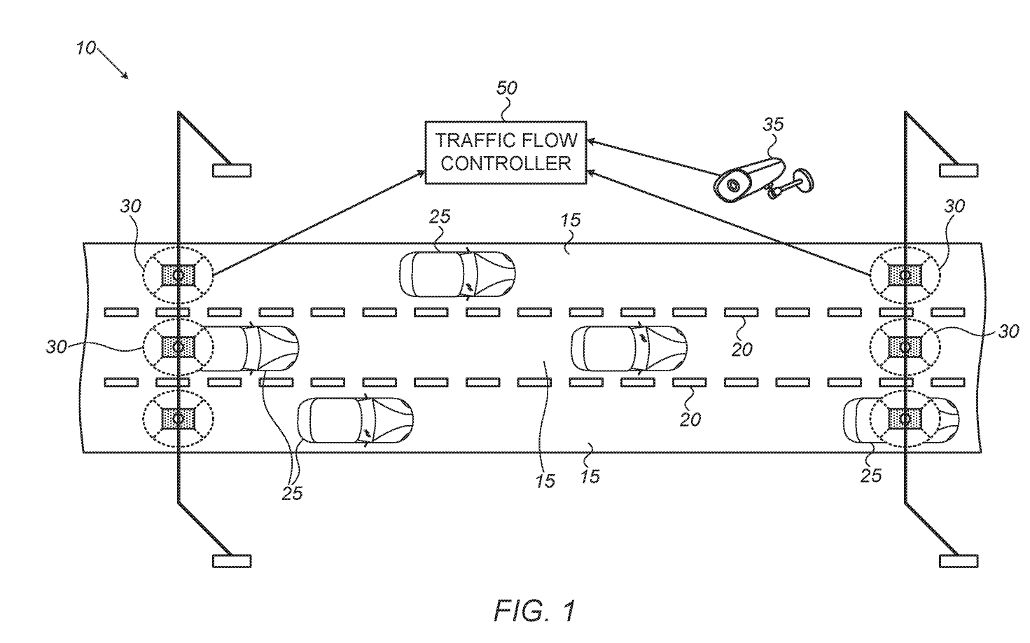

FIG. 1 schematically illustrates a section 10 of a roadway monitored by multiple sensors 30, in accordance with some embodiments of the present invention. Multiple vehicles 25 travel in traffic lanes 15. Traffic lanes 15 are separated by road markings 20, in this case, painted stripes on the roadway so as to delineate multiple lanes 15. Multiple sensors 30 and multiple video cameras 35 (also referred to herein as “sensors”) collect information along section 10 related to vehicle speed, number of vehicles, traffic density, distance between vehicles, and other roadway parameters. This information may be relayed to traffic flow controller 50 which is configured to receive and process the information from multiple sensors 30 and traffic video cameras 35.

The length of the roadway may be partitioned into multiple sections 10 of any given length and given width for the purpose of analyzing traffic flow on that stretch of roadway and/or other parts of that roadway, as described in the embodiments herein. In some embodiments, the length of section 10 may be defined by a start position along the roadway at an entrance ramp, or on-ramp to the roadway, and an end position at an off-ramp or exit from the roadway.

In the embodiments shown in FIG. 1, multiple sensors 30 are placed over the lanes of the roadway at two locations along section 10, which is merely for conceptual clarity and not by limitation of the embodiments of the present invention. The sensors may be placed at one or multiple positions along section 10 of the roadway. In other embodiments, sensors positioned along the sides of the roadway may be used. In yet other embodiments, multiple sensors 30 may include pneumatic road tubes placed across lanes 15 of section 10 of the roadway for vehicle counting and speed measurements. In some embodiments, multiple sensors 30 may be configured to collect vehicular information which is relayed between global positioning system (GPS) satellites. Multiple sensors 30 may relay the detected information related to vehicular speed on section 10 to a GPS system.

Multiple sensors 30 may use sensor technologies that include, but are not limited to inductive loop sensors, magnetometers, magnetic induction coils, microwave radar, active infrared, passive infrared, ultrasonic, and acoustic arrays. Video camera 35 may include a video image processor. Video camera 35 may be configured to identify and count vehicles as well as to calculate average vehicle speeds. In other embodiments, the camera may provide images on a video monitor for a user, or operator, of the system viewing the monitor to assess the traffic conditions.

The term “vehicles” as used herein may be used interchangeably with cars, trucks, motorcycles, and any type of vehicle that uses the roadway. The roadway may be in an urban or rural setting, for example.

The width of traffic lanes 15 may be designed for the maximum speed that vehicles may travel on the traffic lanes safely. For example, for high speeds at 70 KPH, or higher, the lane width may be 3.6 meters. At low speeds such as 30 KPH, the lane width may be 2.5 meters. The speeds designated here are merely by way of example, and not by way of limitation of some embodiments of the present invention. The maximum speed rating per lane width may vary, for example, in different countries.

The road supply, or the amount of paved roadway, is related to parameters such as the number of lanes and the width of the lanes. The road supply is fixed at the time that the roadway is fabricated and paved. Stated differently, the road supply in a section of a roadway is the area of roadway, typically paved roadway, which can be used by the vehicles. For example, the road supply may include shoulders of the roadway, which are not typically used to accommodate traffic flow. The effective road supply in a section of roadway is defined herein as the area of the roadway currently being used by the vehicles. That is, the effective road supply is the area fixed by the road markings, and the width of the lanes, for example, and the lanes designated at a given time being currently used by the vehicles.

Vehicular speed is defined herein as the distance a vehicle travels per unit time. The vehicles on the roadway will typically travel at different speeds so that the average vehicular speed of multiple vehicles in a length, or section, of roadway is an important parameter for analyzing traffic flow. The vehicular traffic rate is defined herein by the number of vehicles that can traverse a given section of roadway in a given time. Similarly, the vehicular capacity of the roadway is defined herein as the maximum number of vehicles that can traverse the given section of roadway in a given time. The traffic density is defined herein as the number of vehicles present in a given length of roadway.

The number of vehicles on the roadway fluctuates during the day. As the number of vehicles increases particularly during peak hours, such as the morning or evening rush hours, and approaches the vehicular capacity of the roadway, the onset of traffic congestion may occur. This results in a decrease in the speed of the vehicles on the roadway. As the number of vehicles increase and the vehicular traffic rate approaches the vehicular capacity of the roadway, traffic congestion occurs throughout multiple sections of the roadway. For example, in the case of a traffic accident where a damaged vehicle blocks one or more lanes of the roadway, a stationary bottleneck occurs in the traffic flow. A moving bottleneck is where a particular vehicle is moving slower than the average vehicular speed of the other vehicles in the section of roadway, which causes a disruption in the traffic flow. A traffic jam is a condition where the roadway is so congested that the vehicles can no longer move, or travel in a stop-and-go motion.

In peak times when there is a large demand for the road supply, or where conditions of traffic congestion are present in a section of the roadway, the average speed of the vehicles traveling in a section of the roadway with its predefined number of lanes decreases significantly. For example, when the vehicular average speed of vehicles in high speed lanes decrease below 30 KPH, but the width of the lanes is 3.6 meters (e.g., lanes widths designed for high speeds above 70 KPH), the effective road supply is no longer optimally used. At average vehicular speeds of 30 KPH, for example, lane widths for accommodating the lower speeds may be smaller, such as 2.5 meters. Hence, for traffic lanes designed for high speeds on a multi-lane roadway, there is over one meter of superfluous lane width per lane given these exemplary width-speed safety ratings that is not utilized at lower vehicle speeds during conditions, for example, of traffic congestion and high road supply demand. This causes a redundancy in the effective road supply in a multi-lane roadway. For a lower speeds, the required lane width and shoulder width is narrower than those required for higher speeds.

In some embodiments of the present invention, this redundancy is used to increase the vehicular capacity of the roadway during times of traffic congestion. For example in a three lane highway using the exemplary width-speed ratings as described above, there is over three meters of superfluous lane width that can be used to create a new lane. Upon meeting a condition such as, for example, when a traffic congestion conditions exists, the average speed of the vehicles on the roadway decreases. In this condition, the number of lanes across a given width of roadway may be changed from a first number of lanes to a second number of lanes, where the first number is smaller than the second number, and the increased number of lanes is narrower. In this manner, even though the average vehicular speed is lower in traffic congestion, the narrower second number of lanes can accommodate a higher vehicle capacity over a given width of section 10. When the traffic congestion dissipates, the number of lanes can then be decreased to fewer, but wider lanes to accommodate traffic with higher vehicular speeds, e.g., normal traffic flow.

In some embodiments of the present invention, the width of the individual lanes may vary from lane to lane over a given width of the roadway. In other embodiments, vehicular traffic in some of the lanes in a given width of the roadway may be in opposite directions. In some embodiments, narrow cycle lanes may be formed to accommodate traffic from bicycles and mopeds, for example. In other embodiments, wider lanes may be formed to accommodate trucks.

In some embodiments of the present invention, upon meeting the condition where the time of day is within a time period known to have increased traffic congestion over a given section and/or width of the roadway, (e.g., during the morning and/or evening rush hours), a change in the number of lanes during traffic congestion may be actuated from a first number of lanes to a second number of lanes, where the first number is smaller than the second number during rush hour. The time period may vary on different days.

In some embodiments of the present invention, road markings on the roadway may include painted markers, such as painted stripes of different colors or different shapes. For example, white painted stripes may delineate a first number of wider lanes to be used during times of normal traffic. Yellow painted stripes, for example, may delineate a second number of narrower lanes during traffic congestion. During time periods of increased traffic congestion, other road markings, such as road signs, active road signs, gantries and/or variable message signs, may be used to notify driver to use the yellow lanes for this example.

The following embodiments describe methods and systems using road markings to implement a change in the number of traffic lanes on the roadway. In some embodiments, a user may manually actuate a change in the number of lanes. In other embodiments, traffic flow controller 50 may use sensors to collect data on traffic conditions and to automatically actuate a change in the number of traffic lanes upon meeting a condition, such as traffic congestion.

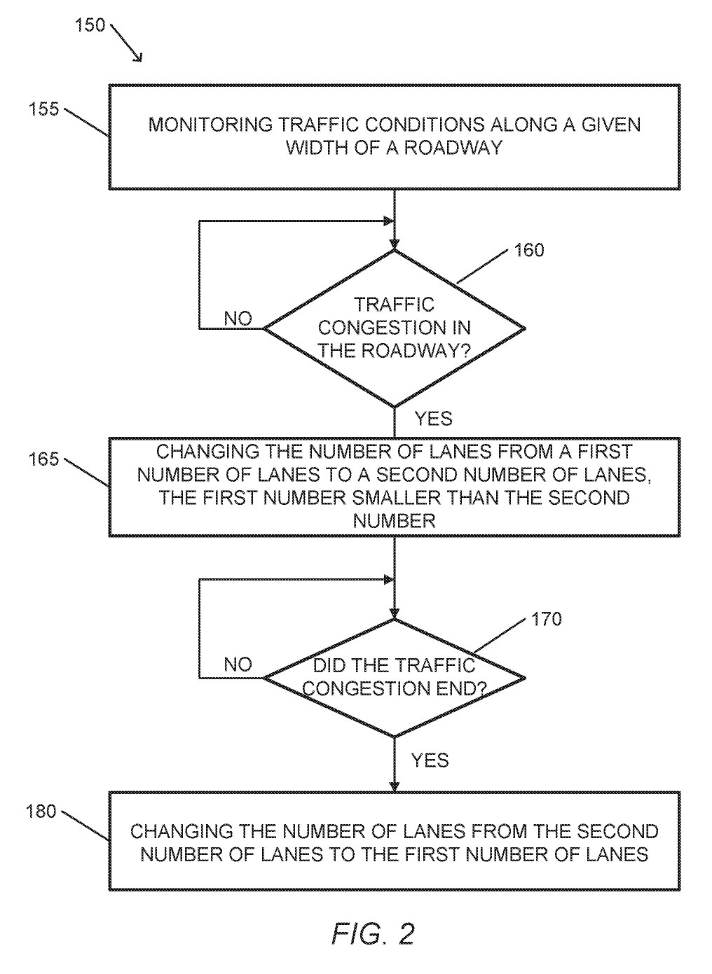

FIG. 2 is a flowchart depicting a first method 150 for traffic flow management by adaptive lane control, in accordance with some embodiments of the present invention of a roadway. Method 150 includes monitoring 155 traffic conditions along a given width of section 10 as shown in FIG. 1. Method 150 includes assessing if there is traffic congestion in the roadway. If there is no congestion, traffic conditions continue to be monitored as in step 155.

However, if there is traffic congestion, method 150 includes changing the number of lanes from a first number of lanes to a second number of lanes where the first number is smaller than the second number in the given width of the roadway. During traffic congestion, the number of lanes is increased in the given width of roadway but the width of the lanes is smaller across the given width of roadway in section 10. This increases vehicular capacity along the given width of section 10 of the roadway when the average vehicular speed is lower due to traffic congestion.

Method 150 includes assessing 170 if the traffic congestion in the roadway ended. If the traffic congestion did not end, the roadway maintains the second number of lanes. If the traffic congestion ended, method 150 includes changing 180 the number of lanes from the second number of lanes to the first number of lanes. The fewer, but wider first number of lanes can now accommodate higher average vehicular speeds as the traffic congestion dissipates and a normal traffic flow returns.

In some embodiments of the present invention, monitoring 155 of the traffic conditions may include a user observing and assessing traffic conditions. The user may manually actuate a change in the road marking along section 10 in response to the user's traffic condition assessment. In other embodiments, as described below, the traffic conditions along section 10 of the roadway may be monitored by sensors 30 and/or video cameras 35. TFC 50 can be used to change the road markings upon meeting a condition, e.g., assessing traffic congestion, for example.

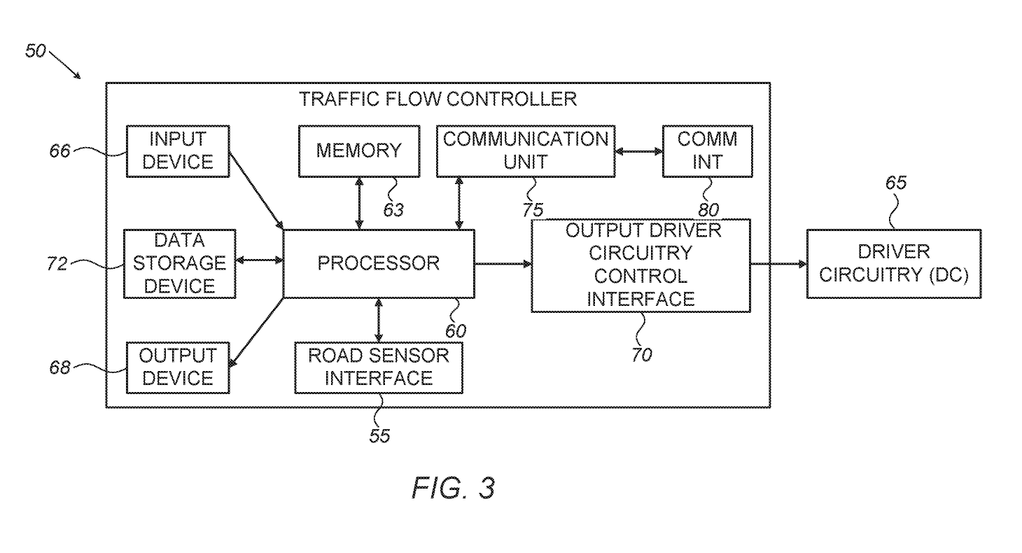

FIG. 3 schematically illustrates a block diagram of traffic flow controller (TFC) 50, in accordance with some embodiments of the present invention. A road sensor interface 55 is configured to receive information from one or a plurality of sensors (e.g., multiple sensors 30 and video camera 35) about traffic conditions along section 10 of the roadway as in FIG. 1. Road sensor interface 55 may receive the information via wired bus lines, or wirelessly from sensors 30 and/or video camera 35. This information may be relayed to and collected by a processor 60 for processing which may store data in a memory 63.

Processor 60 is configured to compute one or more traffic parameters from the data, or information, collected from the one or said plurality of sensors (e.g., multiple sensors 30 and video cameras 35). Multiple sensors 30 and video cameras 35 may relay information to processor 60 and/or the collected information may be stored in memory 63. The information may include, for example, the average vehicular speed on section 10, the average distance between vehicles moving in traffic lane 15, and the number of vehicles traversing section 10 in a given time determined using the one or said plurality of sensors. Processor 60 may use this received information to compute traffic parameters in section 10 such as the traffic density on the roadway, the vehicular traffic rate (e.g., hourly rate of traffic) passing through section 10, or any other suitable traffic parameters for assessing traffic flow conditions in section 10.

Processor 60 may include one or more processing units, e.g. of one or more computers. Processor 60 may be configured to operate in accordance with programmed instructions stored in memory 63. Processor 60 may be capable of executing an application for traffic flow management with adaptive lane control.

Processor 60 may communicate with output device 68. For example, output device 68 may include a computer monitor or screen. Processor 60 may communicate with a screen of output device 68 to display traffic flow information to an operator. In another example, output device 68 may include a printer, display panel, speaker, or another device capable of producing visible, audible, or tactile output.

Processor 60 may communicate with input device 66. For example, input device 66 may include one or more of a keyboard, keypad, or pointing device for enabling a user to inputting data or instructions for operation of processor 60.

Processor 60 may communicate with memory 63. Memory 63 may include one or more volatile or nonvolatile memory devices. Memory 63 may be utilized to store, for example, programmed instructions for operation of processor 60, data or parameters for use by processor 60 during operation, or results of operation of processor 60.

Processor 60 may communicate with data storage device 72. Data storage device 72 may include one or more fixed or removable nonvolatile data storage devices. For example, data storage device 72 may include a computer readable medium for storing program instructions for operation of processor 60. It is noted that data storage device 72 may be remote from processor 60. Data storage device 72 may be utilized to store data or parameters for use by processor 60 during operation, or results of operation of processor 60.

In some embodiments, one TFC 50 may be used to perform all of the functions described herein. In other embodiments, one or multiple TFCs may be placed along multiple sections of a roadway at determined locations. The TFCs may communicate with each other via a communication unit 75 using a wireless protocol. In yet other embodiments, the TFCs may communicate via communication unit 75 over a wired connection. The signals in the wired connection may be coupled to communication unit 75 via a communication interface 80. In other embodiments, communication unit 75 may be configured to communicate with multiple GPS satellites and utilize collective maps (e.g., open source maps) for analyzing traffic flow over section 10. In some embodiments, communication unit 75 may be configured to communicate with devices selected from the group consisting of drones hovering over section 10 of the roadway monitoring traffic conditions, wireless base stations, GPS satellites, control towers, and other traffic flow controllers.

In some embodiments, road markings 20 may include painted surface markings such as painted stripes on the roadway so as to delineate traffic lanes 15 in normal traffic conditions. The stripes may be formed from thermoplastics and epoxies. In other embodiments, road markings may include lane light markers embedded in the pavement, or asphalt, of the roadway. The lane light markers may be formed from in-pavement light emitting diode (LED) markers so as to delineate roadway lanes, curves, and ramps. The lane light markers may be circular or rectangular. The lane light markers may be of any color. Thus a driver on the roadway may view road markings which may include painted surface road markings (e.g., painted stripes), lane light markers, or any combination thereof to delineate the traffic lanes.

In some embodiments of the present invention, road markings 20 may include raised profile markings which may be mechanically raised or recessed into the road surface. The raised profile markings may be reflective or non-reflective.

Driver circuitry (DC) 65 may include circuitry that is configured to drive, or power, the lane light markers and to toggle the lane light markers by switching the markers on and off. DC 65 may be deployed at different positions along section 10 and may be controlled by commands from one central TFC 50 via an output driver circuitry control interface 70. In other embodiments, multiple TFCs 50 may be used to control one or a plurality of DC 65. In some embodiments, DC 65 may be configured to toggle any other active road markings such as raised profile markings.

Active road markings as referred to herein may include lane light markers, mechanical raised profile markings, and the like, which may be driven and/or powered by DC 65. Toggling the road markings, or active road markings, as referred to herein may include turning the lane light markers on and off, or raising and recessing the mechanical raised profile markings, for example.

In some embodiments of the present invention, TFC 50 and/or DC 65 may be powered by solar energy (e.g., with solar panels).

In some embodiments of the present invention, when TFC 50 detects traffic congestion from the one or more traffic parameters, TFC 50 may instruct DC 65 to toggle the road markings on the roadway via a DC output interface 70 so as to add additional lanes to the roadway by using the redundant effective road supply to create one or more additional lanes. The increase in the number of lanes from a first number of lanes to a second number of lanes upon assessing a state of traffic congestion includes reducing the width of the lanes to widths designed for slower average vehicle speeds as described previously. In other embodiments, additional, but unused road supply may also be utilized, such as the roadway shoulders, to add active lanes to the congested roadway. In some embodiments, the width of the roadway shoulders may be decreased so as to increase the given width of the roadway, offering additional space for traffic lane distribution.

In some embodiments of the present invention, a traffic congestion condition may be present along a section 10 of the roadway when a traffic parameter, such as the vehicular traffic rate passes a traffic congestion threshold. In other embodiments, the onset of traffic congestion may be assessed when the vehicular traffic rate exceeds 70% of the vehicular capacity (e.g., a traffic congestion threshold) along section 10 in the roadway. This is equivalent to about 1400 vehicles per hour in a three lane roadway. When processor 60 detects this condition, processor 60 may actuate a change in the number of lanes into narrower lanes where the average vehicular speed is slow enough to safely travel within the narrower but increased number of lanes, thus better utilizing the redundant road supply. The one or more additional lanes increase the vehicular capacity of section 10 of the roadway and reduce congestion, even though the vehicles may travel at slower average vehicular speeds under these conditions.

In some embodiments of the present invention, processor 60 may be configured to use past information on traffic congestion stored in memory 63 for system learning, such that based on past traffic patterns, the distribution of lanes across the given width of the roadway may be set.

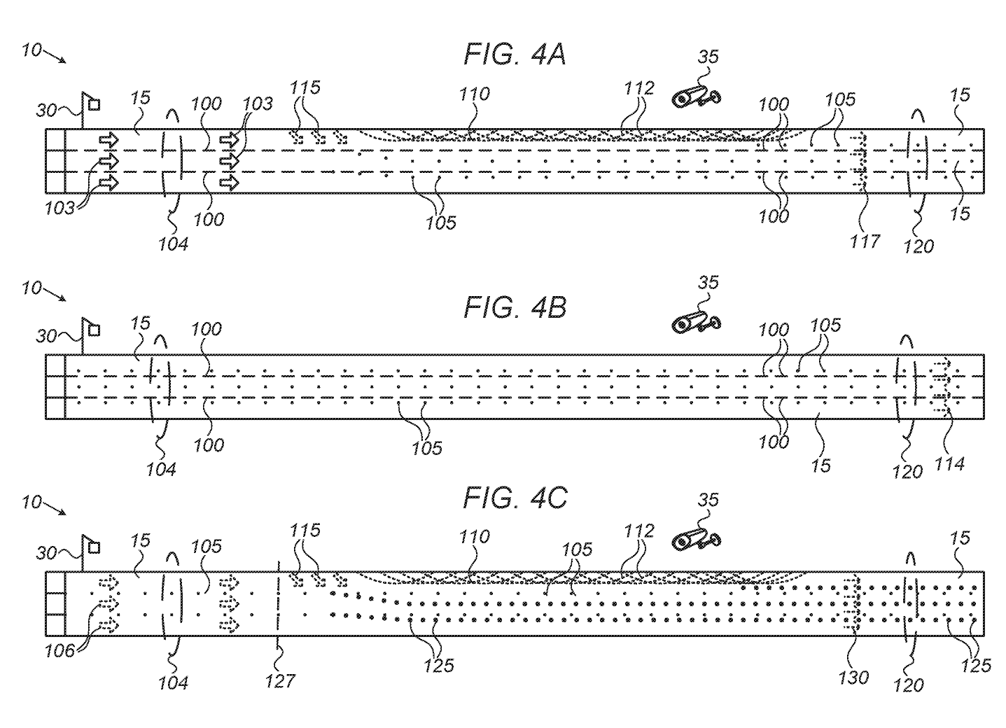

FIG. 4A schematically illustrates a first configuration for increasing the number of traffic lanes by toggling road markings along section 10 of a roadway, in accordance with some embodiments of the present invention. In normal traffic conditions, vehicle drivers in vehicles 25 may view painted arrows 103 and painted stripes 100 on section 10 of the roadway which delineate the boundaries of three traffic lanes 15 shown in a region 104. Road markings such as lane light markers 105 may be embedded into the surface of the roadway in any positions around and/or on painted lines 100. When the lane light markers are off, the vehicle drivers sees painted lines 100 delineating three traffic lanes 15.

In some embodiments of the present invention, when TFC 50 detects traffic congestion from the one or more traffic parameters, TFC 50 actuates a change in the number of lanes from three lanes to four lanes. Processor 60 instructs DC 65 to illuminate lane light markers 105 via interface 70. The vehicle driver now sees the new lanes delineated by lane light markers 105, in this case four traffic lanes 15 shown by the dots (e.g., lane light markers 105) in a region 120. However, the intensity of lane light markers 105 is bright enough to be clearly visible during the day or night such that the driver can discern the four illuminated lanes over the three painted stripe lanes in the pavement.

In the embodiment shown in FIG. 4A, light markers 112 define an illuminated shoulder 110 to direct and to aid the drivers to enter a region transitioning from three lanes to four lanes along the length of illuminated shoulder 110, which reduces a portion of the available roadway. The reduced portion is used to create a fourth narrower traffic lane. Illuminated arrows 115 further direct vehicle drivers into the transition region. After the transition region, there are four lanes in region 120 delineated by lane light markers 105. Lane light markers 105, light markers 112 defining the transition region, and illuminated arrows 115 and 117 may include LEDs with different colors and different shapes and may be driven by DC 65. Additionally, TFC 50 may be used to control road signs, active road signs, gantries and/or variable message signs, to further notify drivers of the change in the configuration of the traffic lanes.

FIG. 4B schematically illustrates a second configuration for increasing the number of traffic lanes by toggling road markings along section 10 of a roadway, in accordance with some embodiments of the present invention. Three traffic lanes are defined, or delineated, by road markings including painted stripes 100. When TFC 50 detects traffic congestion, processor 60 instructs DC 65 to illuminate lane light markers 105 to define four lanes. In some embodiments, DC 65 may configure lane light markers 105 to flash in a sequenced manner so as to visually guide the vehicle drivers to enter the correct traffic lanes in the transition region between the three to four lanes. Additionally, TFC 50 may be used to control road signs, active road signs, gantries and/or variable message signs, to further notify drivers of the change in the configuration of the traffic lanes.

FIG. 4C schematically illustrates a third configuration for increasing the number of traffic lanes by toggling road markings along section 10 of a roadway, in accordance with some embodiments of the present invention. Road markings may include lane light markers in different shape, sizes, and colors. In normal traffic conditions, vehicle drivers in vehicles 25 may view illuminated arrows 106 and small lane light markers 105 delineating three lanes as in region 104.

When TFC 50 detects traffic congestion from the one or more traffic parameters, TFC 50 changes the number of lanes from three lanes to four lanes. Processor 60 instructs DC 65 to switch off a first set of lane light markers 105 to the right side of a plane 127, and to illuminate a second set of larger lane light markers 125 as well as guide arrows 115 and 130, and light markers 112 to form illuminated shoulder 110. The vehicle driver now sees the new lanes delineated by lane light markers 125 and illuminated guide arrows 130, in this case four traffic lanes 15 shown in a region 120 and illuminated arrows 130. Note that, in the configuration as shown in FIG. 4C where the road markings only include lane light markers, the transition regions between a first number of lanes to a second number of lanes can be easily interspersed with this configuration at any points along sections of the roadway. Additionally, TFC 50 may be used to control road signs, active road signs, gantries and/or variable message signs, to further notify drivers of the change in the configuration of the traffic lanes.

In other embodiments, lane light markers 105 that may be used to delineate the three lanes as in FIG. 4C may be shaped as a rectangular stripe (e.g., rectangular LEDs) similar to painted stripes 100 in FIGS. 1 and 4A-4B. In traffic congestion, larger circular lane light markers 125, for example, may be used to delineate four narrower lanes for the vehicle driver to visually distinguish between the three and four lane configurations.

Note that section 10 of the roadway, as shown in FIGS. 4A-4C, are enlarged regions for conceptual clarity to illustrate different configurations where the roadway transitions from three lanes to four lanes. However, in some embodiments, the transition regions between three to four lanes may include a small portion of the entire length of section 10. Multiple sensors 30 and video cameras 35 as shown in FIGS. 4A-4C may be deployed at any positions along the roadway and are not limited to the positions shown in FIGS. 4A-4C.

The roadway as shown in FIG. 4A-4C is not limited to splitting from three to four lanes, but may split from a first number of lanes to a second number of lanes, where the width of the traffic lanes in a first portion of section 10 with the first number of lanes is larger than the width of the traffic lanes in a second portion of section 10 with the second number of lanes when TFC 60 detects traffic congestion.

In some embodiments of the present invention, a user, or operator, such as a policeman, may assess traffic conditions visually and/or using output device 68 and manually actuate a change in the road markings based on the user's assessment, for example via input device 66.

When traffic congestion is present, the traffic flow control system increases the number of lanes in the roadway from a first number of lanes to a second number of lanes. However, when the traffic congestion starts to dissipate, the fewer but wider lanes may be restored so as to result in a normal traffic flow to accommodate larger average vehicular speeds on the roadway. Stated differently, when TFC 50 assesses that a traffic parameter such as the vehicular traffic rate passes the normal traffic flow threshold (e.g., the determined threshold), processor 60 instructs DC 65 to toggle the road markings so as to decrease the number of traffic lanes from a first number to a second number, the first number greater than the second number.

In some embodiments, to assess a normal traffic flow, or a reduction in traffic congestion, may be to include TFC 50 assessing when the vehicular traffic rate drops below 70% of the vehicular capacity (e.g., normal traffic flow threshold) along section 10 in the roadway.

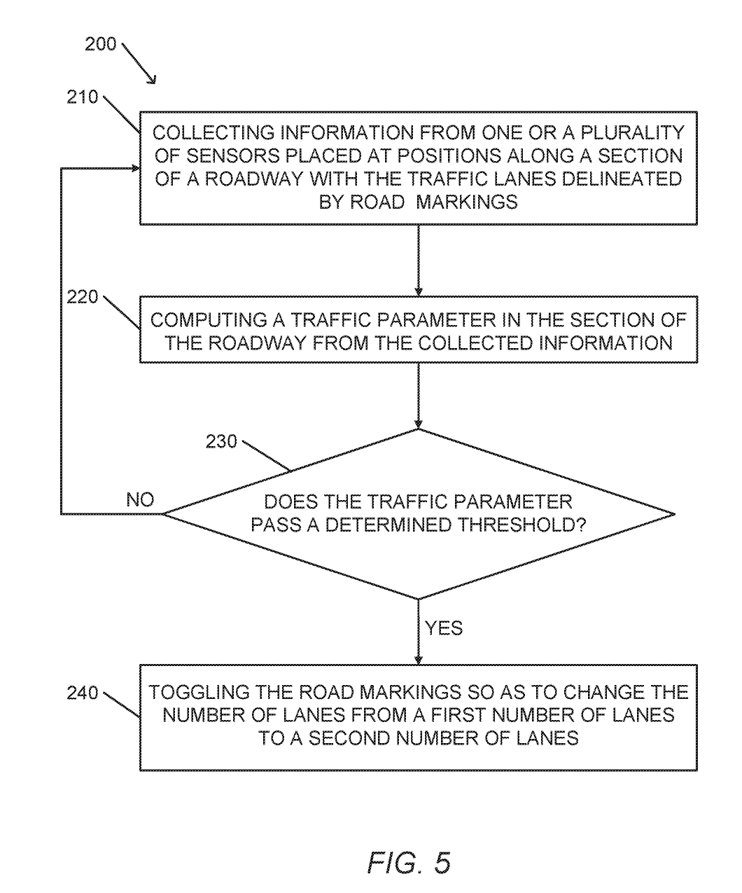

FIG. 5 is a flowchart depicting a second method 200 for traffic flow management by adaptive lane control, in accordance with some embodiments of the present invention. Method 200 includes TFC 50 collecting 210 information from sensors 30 placed at positions along section 10 of a roadway with traffic lanes 15 delineated by road markings 20. Method 200 includes TFC 50 computing 220 a traffic parameter in section 10 of the roadway from the collected information. TFC 50 detects in a decision step 230 whether the computed traffic parameter passes a determined threshold in section 10 of the roadway. If not, method 200 includes that TFC 50 continues collecting 210 information from sensors 30. If so, method 200 includes DC 65 toggling 240 the road markings so as to change the number of lanes from a first number of lanes to a second number of lanes.

The embodiments taught herein are not limited to section 10 of the roadway, but may be applied to one or more sections of the roadway, or the entire roadway. The traffic parameters computed from the information received from the sensors and preloaded traffic data or parameters stored in memory 63, may be used to evaluate traffic conditions. Processor 60 may use this to determine whether to actuate a change in the number of lanes so as to increase vehicular capacity and improve traffic flow in the roadway.

In some embodiments of the present invention, tracking tag technology may be used to delineate traffic lanes along the roadway. Road markings may include rows of tracking tags affixed to the roadway either on the roadway surface or embedded within the roadway material such as asphalt. The row of tracking tags may or may not be visible to the driver. However, vehicles, such as smart or autonomous vehicles, may include circuitry to detect and navigate between two rows of tracking tags delineating a traffic lane on the roadway. The smart vehicle is steered within the traffic lane delineated by the two rows of detected tracking tags. In some embodiments, the tracking tags may include radio frequency identification (RFID) tracking tags.

In times of traffic congestion, the smart vehicle circuitry may receive instructions (e.g., from TFC 50, for example) over wireless protocols such as GPS, cellular data (e.g., 3G, 4G, Long Term Evolution—LTE), Wi-Fi or by any other means to detect an alternative two rows of tracking tags. The smart vehicle effectively changes lanes by detecting the alternative two rows of tracking tags defining a narrower traffic lane and the smart vehicle is configured to be steered with the narrower traffic lane delineated by the detected alternative two rows of tracking tags. In some embodiments, multiple traffic lanes may be distinguished by rows of tracking tags with different tag types, different tag IDs, and any other distinguishing parameters.

In some embodiments of the present invention, the smart vehicle circuitry may also include detectors which can identify changes in the traffic lanes delineated by the road markings as described in the previous embodiments herein, and are not limited to traffic lanes delineated by tracking tags.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus certain embodiments may be combinations of features of multiple embodiments. The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for managing traffic flow on a roadway, the method comprising:
upon meeting a condition, changing a number of traffic lanes from a first number to a second number across a given width of the roadway.

2. The method according to claim 1, wherein the condition comprises traffic congestion in the roadway, and wherein changing the number of traffic lanes comprises changing the number of traffic lanes such that the first number is smaller than the second number.

3. The method according to claim 2, wherein changing the number of traffic lanes comprises manually actuating a change the number of traffic lanes by a user.

4. The method according to claim 2, further comprising changing the number of traffic lanes from the second number to the first number upon assessing a normal traffic flow in the roadway.

5. The method according to claim 1, wherein the condition comprises a time of day within a time period of traffic congestion.

6. The method according to claim 1, and further comprising:
collecting information from one or a plurality of sensors placed at positions along a section of the roadway with traffic lanes delineated by road markings; and
computing a traffic parameter in the section of the roadway from the collected information from the one or said plurality of sensors;
wherein changing the number of lanes comprises toggling the road markings.

7. The method according to claim 6, wherein the traffic parameter comprises a vehicular traffic rate in the section, and wherein collecting the information comprises determining, using the one or said plurality of sensors, an average speed of vehicles in the section and a number of vehicles in the section for computing the vehicular traffic rate.

8. The method according to claim 6, wherein the one or said plurality of sensors are selected from the group consisting of an inductive loop sensor, a magnetometric sensor, a magnetic induction coil sensor, a microwave radar sensor, an active infrared sensor, a passive infrared sensor, an ultrasonic sensor, an acoustic array sensor, a pneumatic tube sensor, and a video image processing sensor.

9. The method according to claim 6, wherein the road markings comprise painted stripes delineating the traffic lanes with the first number, and lane light markers delineating the traffic lanes with the second number, and wherein toggling the road markings comprises illuminating the lane light markers.

10. The method according to claim 6, wherein the road markings comprise a first set of lane light markers delineating the first number of traffic lanes and a second set of lane light markers delineating the second number of traffic lanes on the roadway, and wherein toggling the road markings comprises switching off the first set of lane light markers and illuminating the second set of lane light markers.

11. A traffic flow control system for managing traffic flow on a roadway, the system comprising:
road markings; and
a controller configured to change a number of traffic lanes from a first number to a second number across a given width of the roadway when a condition is met.

12. The system according to claim 11, wherein the condition comprises traffic congestion in the roadway, and wherein the controller is configured to change the number of traffic lanes by changing the number of lanes such that the first number is smaller than the second number.

13. The system according to claim 12, wherein the controller is configured to change the number of traffic lanes from the second number to the first number upon assessing a normal traffic flow in the roadway.

14. The system according to claim 11, wherein the controller is configured to collect information from one or a plurality of sensors placed at positions along a section of the roadway with traffic lanes delineated by road markings, and to compute a traffic parameter in the section of the roadway from the collected information from the one or said plurality of sensors,
wherein the controller is configured to change the number of lanes by toggling the road markings.

15. The system according to claim 14, wherein the traffic parameter comprises a vehicular traffic rate in the section, and wherein the controller is configured to collect the information by determining, using the one or said plurality of sensors, an average speed of vehicles in the section and a number of vehicles in the section for computing the vehicular traffic rate.

16. The system according to claim 14, wherein the road markings comprise painted stripes delineating the traffic lanes with the first number, and lane light markers delineating the traffic lanes with the second number, and wherein the controller is configured to toggle the road markings by illuminating the lane light markers.

17. The system according to claim 14, wherein the road markings comprises a first set of lane light markers delineating the first number of traffic lanes and a second set of lane light markers delineating the second number of traffic lanes on the roadway, and wherein the controller is configured to toggle the road markings by switching off the first set of lane light markers and illuminating the second set of lane light markers.

18. The system according to claim 11, further comprising a communication unit for communicating with devices selected from the group consisting of GPS satellites, drones, control towers, wireless base stations, and other traffic flow controllers.

19. The system according to claim 11, wherein the road markings comprise lane light markers formed from light emitting diodes.

20. The system according to claim 11, wherein the road markings comprise tracking tags to delineate the traffic lanes along the roadway.
